(19) United States
(12) Patent Application Publication
(10) Pub. No.: US 2007/0174571 A1
(43) Pub. Date: Jul. 26, 2007

(54) Binding a protected application program to shell code

(75) Inventor: Laszlo Elteto, Irvine, CA (US)

Correspondence Address: VENABLE LLP, P.O. BOX 34385, WASHINGTON, DC, 20043-9998, US

(73) Assignee: Safenet, Inc., Belcamp, MD (US)

(21) Appl. No.: 11/338,690

(22) Filed: Jan. 25, 2006

(51) Int. Cl. G06F 12/14

(52) U.S. Cl. 711/163

(57) ABSTRACT

A system and method for binding a protected application to a shell module. The shell module is appended to the application. The shell module executes prior to the execution of the application, and first creates a resource. After the shell module finishes execution, the application tries to access the created resource. If the access is successful, the application is allowed to proceed. Otherwise, the application terminates. The inability of the application to access the resource is an indication that the shell module never actually created the resource. This suggests that the shell module never executed; the shell module may have been either removed or functionally disconnected from the application. This further implies that the security functionality of the shell module has not executed. The application is therefore not permitted to execute, since the shell's security checks have probably not been performed.

### BACKGROUND OF THE INVENTION

1. Field of the Invention

The invention described herein relates to digital rights management and more particularly to the prevention of unauthorized use of software.

2. Related Art

One of the longstanding problems in the commercial distribution of software is controlling the use of the software. From the perspective of the software developer, only the party who has purchased or licensed the software may use the software. There may be other restrictions in place as well. For example, the software developer may wish to restrict use of the software on a particular machine. The developer may also wish to restrict the time interval during which the software may be used. Such restrictions, if enforced, limit the conditions under which a software package is used. Use of a software package, i.e., use that is outside the boundaries of what is specified in restrictions such as those above, represents unauthorized use. From the perspective of the software developer, software should only be used under conditions specified by the software developer, in agreement with the purchaser or licensor. Use of the software package outside of these conditions represents use that has not been paid for. Such unauthorized use therefore represents money lost to the software developer.

One solution to the problem of unauthorized use of software involves using an additional software module, known as a shell. This is illustrated in FIG. 1. An application program 110 comprises a header 120, followed by code 130 and data 140. Appended to the end of application 110 is a shell module, shell runtime code 150. A pointer 160 resides in header 120. Pointer 160 assures that shell runtime code 150 executes prior to execution of application 110.

The shell module 150 performs one or more security checks. These checks determine whether various conditions for the use of the software are being met. For example, shell module 150 may determine whether application 110 will be executing on an authorized machine. In addition, shell module 150 may check whether application 110 will be executing within the authorized time window. Shell module 150 may also check whether a security token, if required, is in place. If and only if all the checks in shell module 150 are passed, application 110 can then begin execution.

The use of such a shell module is not always sufficient, however. A hacker may, for example, separate the shell from the application. The shell module may be deleted, or functionally disconnected from the application so that security checks are never made. There is a need, therefore, for a mechanism through which a shell module can be bound to an application, such that if the shell module is deleted or functionally disconnected from the application, the application will not be useable.

### SUMMARY OF THE INVENTION

The invention described herein is a system and method for binding a protected application to a shell module. The shell module is appended to the application. The shell module executes prior to the execution of the application, and first creates a resource. After the shell module finishes execution, the application tries to access the created resource. If the access is successful, the application is allowed to proceed. Otherwise, the application terminates. The inability of the application to access the resource is an indication that the shell module never actually created the resource. This suggests that the shell module never executed; the shell module may have been either removed or functionally disconnected from the application. This further implies that the security functionality of the shell module has not executed. The application is therefore not permitted to execute, since the shell's security checks have probably not been performed.

Further embodiments, features, and advantages of the present invention, as well as the structure and operation of the various embodiments of the present invention, are described below with reference to the accompanying figures.

### BRIEF DESCRIPTION OF THE FIGURES

FIG. 1 illustrates an application program with an appended shell module, according to the prior art.

FIG. 2 illustrates a computing platform on which the invention may execute, according to an embodiment of the invention.

FIG. 3 is a block diagram illustrating an embodiment of the invention in which the shell module allocates a memory location that the application subsequently tries to access.

FIG. 4 is a flow chart illustrating the processing associated with the embodiment of FIG. 3.

FIG. 5 is a block diagram illustrating an embodiment of the invention in which the shell module creates a mutex that the application subsequently tries to access.

FIG. 6 is a flow chart illustrating the processing associated with the embodiment of FIG. 5.

### DETAILED DESCRIPTION OF THE INVENTION

A preferred embodiment of the present invention is now described with reference to the figures, where like reference numbers indicate identical or functionally similar elements. Also, in the figures, the left-most digit of each reference number corresponds to the figure in which the reference number is first used. While specific configurations and arrangements are discussed, it should be understood that this is done for illustrative purposes only. A person skilled in the relevant art will recognize that other configurations and arrangements can be used without departing from the spirit and scope of the invention. It will also be apparent to a person skilled in the relevant art that this invention can also be employed in a variety of other systems and applications.

### I. Overview

The invention described herein is a system and method for binding a protected application to a shell module. The shell module is appended to the application. The shell module executes prior to the execution of the application, and first creates a resource. After the shell module finishes execution, the application tries to access the created resource. If the access is successful, the application is allowed to proceed. Otherwise, the application terminates. The inability of the application to access the resource is an indication that the shell module never actually created the resource. This suggests that the shell module never executed; the shell module may have been either removed or functionally disconnected from the application. This further implies that the security functionality of the shell module has not executed. The application is therefore not permitted to execute, since the shell's security checks have probably not been performed.

### II. System

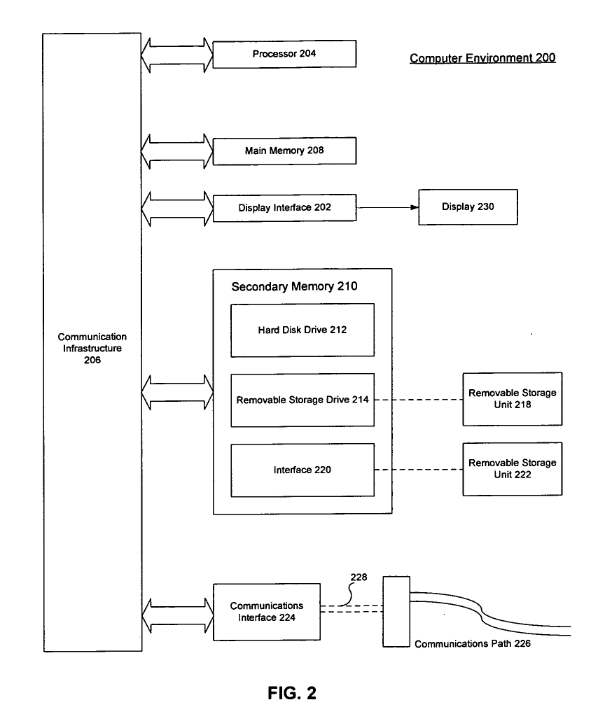

The invention described herein can take the form of software that executes in a computing environment such as the one illustrated in FIG. 2.

An example of a computer system 200 is shown in FIG. 2. The computer system 200 may include one or more processors, such as processor 204. The processor 204 may be connected to a communication infrastructure 206 (e.g., a communications bus or network). After reading this description, it will become apparent to a person skilled in the relevant art(s) how to implement the invention with respect to other computer systems and/or computer architectures.

Computer system 200 may include a display interface 202 that may forward graphics, text, and other data from the communication infrastructure 206 for display on the display unit 230.

Computer system 200 may also include a main memory 208, e.g., random access memory (RAM), and may also include a secondary memory 210. The secondary memory 210 may include, for example, a hard disk drive 212 and/or a removable storage drive 214, representing a magnetic tape drive, an optical disk drive, etc., but which is not limited thereto. The removable storage drive 214 may read from and/or write to a removable storage unit 218 in a well known manner. Removable storage unit 218, may represent a floppy disk, magnetic tape, optical disk, etc., which may be read by and/or written to by removable storage drive 214. As will be appreciated, the removable storage unit 218 may include a computer usable storage medium having stored therein computer software and/or data.

In alternative embodiments, secondary memory 210 may include other similar means for allowing computer programs or other instructions to be loaded into computer system 200. Such means may include, for example, a removable storage unit 222 and an interface 220. Examples of such may include, but are not limited to, a removable memory chip (such as an EPROM, or PROM) and associated socket, and/or other removable storage units 222 and interfaces 220 that may allow software and data to be transferred from the removable storage unit 222 to computer system 200.

Computer system 200 may also include a communications interface 224. Communications interface 224 may allow software and data to be transferred between computer system 200 and external devices. Examples of communications interface 224 may include, but are not limited to, a modem, a network interface (such as an Ethernet card), a communications port, a PCMCIA slot and card, etc. Software and data transferred via communications interface 224 are in the form of signals 228 which may be, for example, electronic, electromagnetic, optical or other signals capable of being received by communications interface 224. These signals 228 may be provided to communications interface 224 via a communications path (i.e., channel) 226. This channel 226 may carry signals 228 and may be implemented using wire or cable, fiber optics, a phone line, a cellular phone link, an RF link and/or other communications channels.

In this document, the terms “computer program medium” and “computer usable medium” are used to generally refer to media such as, but not limited to, removable storage unit 218, a hard disk installed in hard disk drive 212, and/or signals 228. These computer program media are means for providing software to computer system 200.

Computer programs (also called computer control logic) may be stored in main memory 208 and/or secondary memory 210. Computer programs may also be received via communications interface 224. Such computer programs, when executed, enable the computer system 200 to perform the features of the present invention as discussed herein. In particular, the computer programs, when executed, may enable the processor 204 to perform the present invention in accordance with the embodiments described below. Accordingly, such computer programs represent controllers of the computer system 200.

Software embodying the invention may be stored in a computer program product and loaded into computer system 200 using, for example, removable storage drive 214, hard drive 212, interface 220, or communications interface 224. The control logic (software), when executed by the processor 204, causes the processor 204 to perform the functions of the invention as described herein.

### III. Method

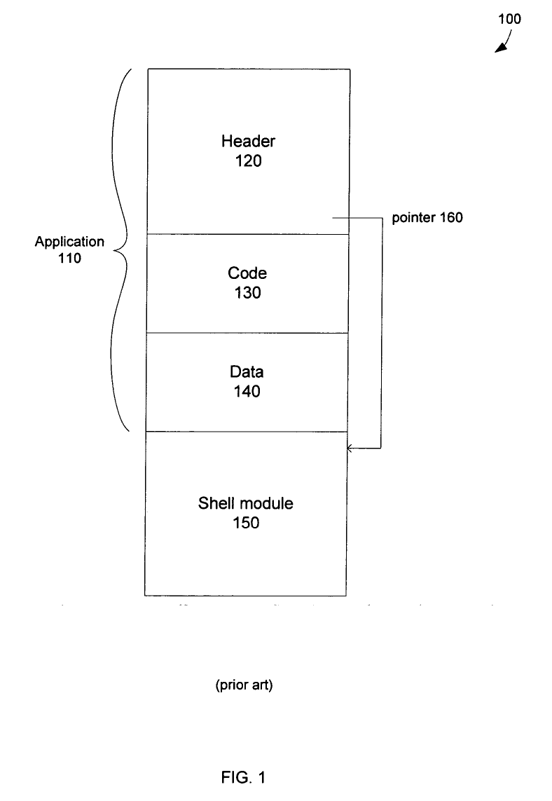

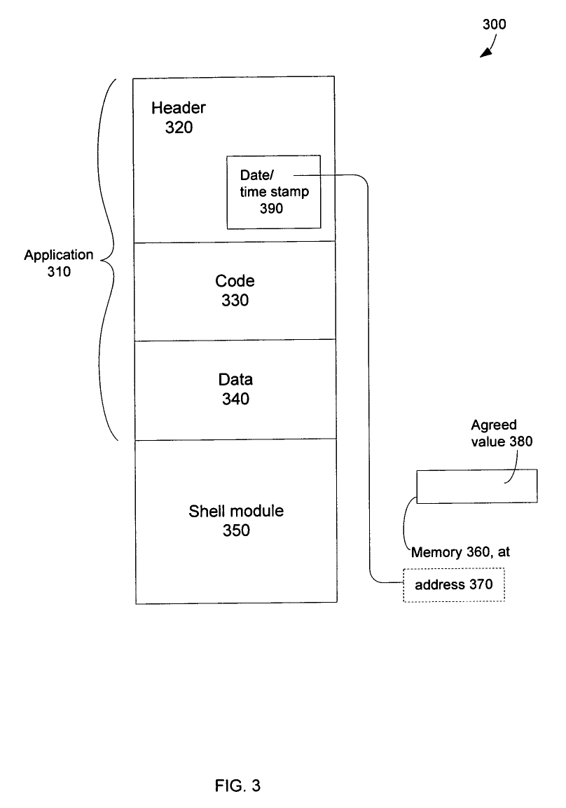

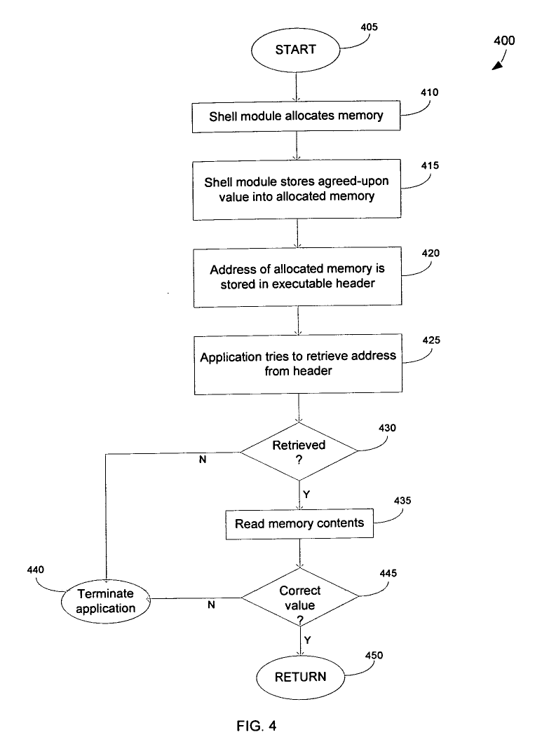

The processing of an embodiment of the invention is illustrated in FIGS. 3 and 4. In FIG. 3, a protected application 310 is shown as consisting of header 320, code 330, and data 340. Appended to the application 310 is shell runtime code 350. The overall processing has some similarities to that of FIG. 1, in that the shell module 350 executes prior to the execution of application 310. Among its other security related functions, shell module 350 allocates memory location 360. Memory location 360 is located at address 370. In addition to allocating memory 360, shell module 350 also stores an agreed upon value 380 in memory location 360. In an embodiment of the invention, the agreed upon value 380 can be a predetermined value provided by the developer of the application 310.

Shell module 350 then stores address 370 in a location readily accessible by the application. In the illustrated embodiment, the address 370 is stored in or with a date/time stamp 390, which is located within header 320.

Once the application begins to execute, the application retrieves address 370, goes to that address, i.e., to memory location 360, and attempts to read the agreed upon value 380. If the value that is read matches the agreed upon value 380, then the application proceeds. If the value does not match, the application 310 terminates. Moreover, if address 370 is not found by the application 310, then the application terminates.

Note that if a hacker succeeds in removing shell module 350, or otherwise functionally disconnects shell 350 from the application, then date/time stamp 390 will not receive an address, and the application will fail to access the memory location 360. Alternatively, the application may have some address in date/time stamp field 390, but the value found at that address would likely not match the agreed upon value 380.

In order to circumvent this sequence of checks, a hacker would now have to simulate the actions of shell module 350. The hacker would have to place an address in the location expected by the application, i.e., date/time stamp field 390. This would be difficult for a hacker to do.

Moreover, this could be made more difficult by obfuscating the stored address 370. The shell module 350 could, for example, take address 370, and combine it in a deterministic reversible manner with some known constant. Address 370 could be combined with the constant using a bitwise XOR operation, for example. The application 310 would then read the obfuscated address from date/time stamp 390 then apply the constant to the obfuscated address in order to recover the actual address 370. In an embodiment of the invention, some of all of the constant is supplied by the application developer.

The processing associated with the embodiment of FIG. 3 is presented in the flow chart of FIG. 4. The process begins at step 405. In step 410, the shell module allocates a memory location. In step 415, the shell module stores an agreed-upon value into the allocated memory location. As discussed above, the agreed-upon value may be provided by the software developer of the application. In step 420, the address of the allocated memory is stored in the executable header of the application. One possible location for storage of the address would be the date/time stamp of the header, as discussed above.

In step 425, the application attempts to retrieve the address from the header. In step 430, a determination is made as to whether this retrieval is successful. If not, the application terminates at step 440. If retrieval is successful, then the process continues at 435. Here, the memory contents are read. In step 445, a determination is made as to whether the correct value has been found in the allocated memory location. If not, the application terminates at step 440. If the correct value is found, as determined in step 445, then the application continues, and the process concludes at step 450.

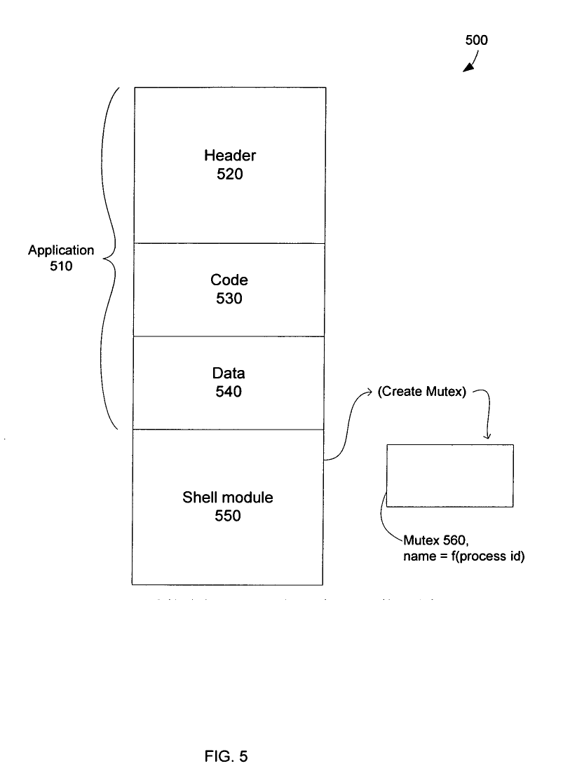

An alternative embodiment of the invention is shown in FIG. 5. Similar to previous illustrations, an application consists of code 530, along with header 520 and data 540. Again, a shell module 550 is appended, where the shell module 550 is used to create a resource. In this embodiment, the shell module 550 creates a mutual exclusion object, or “mutex” 560. A mutex is a program object used by program threads to share access to, say, a data structure such as a file. Any thread that needs the file must lock the mutex against other threads while using the file. The mutex is unlocked when the file is no longer needed or the routine is completed.

Here, the created mutex 560 is given a name by the shell module 550. The mutex name is based on name information. One example of name information is the process ID. The mutex name can therefore be the process ID, or can be based on the process ID. In the illustrated embodiment, the name for the mutex 560 is the value of a function f(process ID). After the shell module 550 completes execution, control returns to code 530.

Code 530 then attempts to recreate the name of the mutex 560. To do so in the example shown, code 530 would have to create the name on the basis of the process ID if the name is a function of the ID. If the name is simply the process ID, code 530 simply obtains the process ID. In either event, code 530 would then attempt to access the named mutex 560. The inability to access mutex 560 would be an indication that the shell module 550 has been deleted, disabled, or otherwise functionally disconnected from the application 510. If shell module 550 were not present or had been disabled, no mutex having a name based on the process ID would have been created by the shell module 550. Code 530 would then be attempting to access a resource that had not been created, and would obviously be unable to do so.

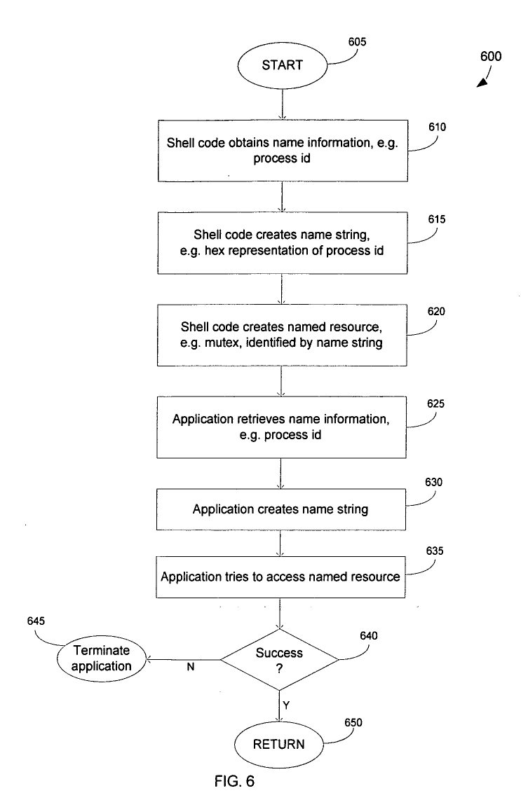

The processing of this embodiment of the invention is illustrated in the flow chart of FIG. 6. This process starts at step 605. In step 610, the shell module obtains name information, i.e., information that will be used to name the mutex to be created. In the example illustrated, the process ID is used as the name information. In step 615, the shell module creates a name string, such as a hex representation of the process ID. In step 620, the shell module creates a named resource such as a mutex, identified by the name string. In step 625, the application retrieves the name information. In step 630, the application creates a name string based on the name information. In step 635, the application attempts to access the resource bearing that name. In step 640, a determination is made as to whether the access to the named resource is successful. If not, the application terminates in step 645. If the attempt to access the named resource is successful, then the process continues at step 650.

Note that in alternative embodiments of the invention, the name information can come from several sources. In the illustrated embodiment, the name information is the process ID. Alternatively, other process specific information can be used to derive a name for the mutex. One possibility is the start time for the process. The name would then be the start time or a function thereof. In yet another alternative embodiment, the name can be based on name information provided by the software developer of the application.

Note also that in alternative embodiments, an object other than a mutex can be created by the shell module. The shell module may create a semaphore, for example, or another sort of named resource. As in the mutex embodiment, the resource can be named on the basis of name information derived from the process or supplied by the application developer. The application can verify the operation of the shell module by attempting to access the resource using the name.

### IV. Conclusion

While some embodiments of the present invention have been described above, it should be understood that it has been presented by way of examples only and not meant to limit the invention. It will be understood by those skilled in the art that various changes in form and detail may be made therein without departing from the spirit and scope of the invention as defined in the appended claims. Thus, the breadth and scope of the present invention should not be limited by the above-described exemplary embodiments, but should be defined only in accordance with the following claims and their equivalents.

What is claimed is:

1. A method of binding a security code shell module to an application, comprising the steps of:
a. creating a resource, performed by the shell module;
b. attempting to access the resource performed by the application; and
c. if the access is not successful, terminating the application.

2. The method of claim 1, wherein the resource comprises allocated memory, said method further comprising:
d. storing an agreed upon value into the allocated memory;
e. saving an indication of the address of the allocated memory, performed by the shell module after step a. and before step b.

3. The method of claim 2, wherein the indication of the address comprises an address of the allocated memory.

4. The method of claim 2, wherein the indication of the address comprises an address of the allocated memory, in combination with a constant known to both the application and the shell module.

5. The method of claim 4, wherein at least a portion of the constant is supplied by a developer of the application.

6. The method of claim 4, wherein the combination of the constant and the address of the allocated memory comprises a bitwise XOR of the known constant and the address.

7. The method of claim 2, wherein at least a portion of the agreed upon value is supplied by a developer of the application.

8. The method of claim 2, wherein the indication of the address of the allocated memory is saved in an executable header of the application.

9. The method of claim 8, wherein said step b. comprises:
i. attempting to retrieve the indication of the address from the executable header, wherein failure to retrieve the indication of the address from the executable header represents unsuccessful access of the resource.

10. The method of claim 9, wherein said step b further comprises:
ii. reading the contents of the allocated memory; and
iii. determining if the read contents match the agreed upon value, wherein failure to match the agreed upon value represents unsuccessful access of the resource.

11. The method of claim 1, wherein the resource comprises a named resource.

12. The method of claim 11, wherein the named resource comprises a mutex.

13. The method of claim 11, wherein a named resource comprises a semaphore.

14. The method of claim 11, wherein said step a comprises deriving a name for the named resource.

15. The method of claim 14, wherein said derivation of the name for the named resource comprises:
i. obtaining name information; and
ii. creating the name based on the name information
and wherein said step b. comprises:
i. retrieving the name information;
ii. creating the name based on the name information; and
iii. attempting to access the named resource using the created name.

16. The method of claim 15, wherein the name information comprises information supplied by a developer of the application.

17. The method of claim 15, wherein the name information comprises a process specific value.

18. The method of claim 17, wherein said process specific value comprises the start time of a process.

19. The method of claim 17, wherein said process specific value comprises a process ID.

20. A computer program product comprising a computer useable medium having computer program logic recorded thereon, which, when executed on a computer, binds a security code shell module to an application, said computer program logic comprising:
first computer program logic, in the shell module, that causes the computer to create a resource;
second computer program logic, in the application, that causes the computer to attempt to access the resource; and
third computer program logic that causes the computer to terminate the application if the access is not successful.

21. The computer program product of claim 20, wherein the resource comprises allocated memory, said computer program product further comprising:
fourth computer program logic that causes the computer to store an agreed upon value into the allocated memory; and
fifth computer program logic that causes the computer to save an indication of the address of the allocated memory,
wherein said fourth and fifth computer program logic execute after said first and before said second computer program logic.

22. The computer program product of claim 21, wherein the indication of the address of the allocated memory is saved in an executable header of the application.

23. The computer program product of claim 22, wherein said second computer program logic comprises:
i. computer program logic that causes the computer to attempt to retrieve the indication of the address from the executable header, wherein failure to retrieve the indication of the address from the executable header represents unsuccessful access of the resource;
ii. computer program logic that causes the computer to read the contents of the allocated memory; and
iii. computer program logic that causes the computer determine if the read contents match the agreed upon value, wherein failure to match the agreed upon value represents unsuccessful access of the resource.

24. The computer program product of claim 20, wherein the resource comprises a named resource.

25. The computer program product of claim 24, wherein said first computer program logic comprises:
i. computer program logic that causes the computer to obtaining name information;
ii. computer program logic that causes the computer to create a name for the resource based on the name information and wherein said second computer program logic comprises:
i. computer program logic that causes the computer to retrieve the name information;
ii. computer program logic that causes the computer to create the name based on the name information; and
iii. computer program logic that causes the computer to attempt to access the named resource using the created name, wherein failure to access the named resource using the created name represents unsuccessful access of the resource.
